(19) United States
(12) Patent Application Publication
(10) Pub. No.: US 2019/0063346 A1
(43) Pub. Date: Feb. 28, 2019

(54) DEVICE AND METHOD FOR CONTROLLING INTERNAL COMBUSTION ENGINE

(71) Applicant: TOYOTA JIDOSHA KABUSHIKI KAISHA, Toyota-shi (JP)

(72) Inventor: Mikio WATANABE, Chiryu-shi (JP)

(73) Assignee: TOYOTA JIDOSHA KABUSHIKI KAISHA, Toyota-shi (JP)

(21) Appl. No.: 16/104,165

(22) Filed: Aug. 17, 2018

(30) Foreign Application Priority Data
Aug. 30, 2017 (JP) 2017-165781

(51) Int. Cl. F02D 41/00; F02M 25/08

(52) U.S. Cl. CPC F02D 41/004; F02D 2700/0215; F02M 25/0836; F02M 25/0854

(57) ABSTRACT

An engine control device includes processing circuitry configured to perform a base injection amount calculation process, a feedback process for correcting a base injection amount based on an output value of an integral element obtained using a difference of detection and target values of an air-fuel ratio as an input value, an injection valve operation process for operating a fuel injection valve based on the corrected base injection amount, a purge control process for operating an adjustment device to control a fluid flow rate from a canister to an intake passage, and a correction limiting process for limiting the output value of the integral element so that a decreasing correction rate of the base injection amount has a decreasing tendency when a charged air amount is decreased if the fluid flow rate is larger than zero.

### BACKGROUND

The present invention relates to a device and method for controlling an internal combustion engine.

Japanese Laid-Open Patent Publication No. 2015-148251 describes an example of a control device that, on condition that fuel cut is not performed, controls the open degree of a purge valve (adjustment device) so that the open degree is larger than zero so that fuel vapor flows out of a canister to an intake passage. The control device corrects the operation amount of a fuel injection valve based on an air-fuel ratio feedback correction amount.

The use of an integral element to calculate the air-fuel ratio feedback correction amount is known in the art.

If the amount of air charged into a combustion chamber is decreased when fuel cut is not performed, a differential pressure obtained by subtracting the pressure in an intake passage from the pressure in a canister is increased. This may increase a purge rate obtained by dividing the flow rate of fluid flowing from the canister to the intake passage by an intake air amount. As the charged air amount decreases and the purge rate increases, the ratio that the fuel vapor from the canister occupies in the air-fuel mixture increases in the combustion chamber. This may richen the air-fuel ratio of the air-fuel mixture. In this case, the decreasing correction rate of an injection amount (positive value for decreasing correction) obtained from an integral element is increased. After the air-fuel ratio of the air-fuel mixture becomes equal to a target air-fuel ratio, the decreasing correction rate remains larger than zero for a while. Thus, the injection amount may be excessively decreased when corrected.

### SUMMARY

Aspects of the present invention and the operation and effect of the aspects will now be described.

1. In a control device for an internal combustion engine, the internal combustion engine includes a fuel injection valve, a canister configured to collect fuel vapor generated in a fuel tank storing fuel supplied to the fuel injection valve, and an adjustment device configured to adjust a flow rate of fluid flowing from the canister to an intake passage. The control device includes processing circuitry configured to perform a base injection amount calculation process for calculating a base injection amount based on a charged air amount in a combustion chamber of the internal combustion engine; a feedback process for correcting the base injection amount based on an output value of an integral element obtained by using a difference between a detection value of an air-fuel ratio and a target value of the air-fuel ratio as an input value to adjust the detection value to the target value through feedback control; an injection valve operation process for operating the fuel injection valve based on the base injection amount corrected by the feedback process; a purge control process for operating the adjustment device to control the flow rate of the fluid flowing from the canister to the intake passage; and a correction limiting process for limiting the output value of the integral element so that a decreasing correction rate of the base injection amount has a decreasing tendency on condition that the charged air amount is decreased if the flow rate of the fluid is controlled to a value larger than zero by the purge control process

In a method for controlling an internal combustion engine, the internal combustion engine includes a fuel injection valve, a canister configured to collect fuel vapor generated in a fuel tank storing fuel supplied to the fuel injection valve, and an adjustment device configured to adjust a flow rate of fluid flowing from the canister to an intake passage. The method includes performing a base injection amount calculation process for calculating a base injection amount based on a charged air amount in a combustion chamber of the internal combustion engine; performing a feedback process for correcting the base injection amount based on an output value of an integral element obtained by using a difference between a detection value of an air-fuel ratio and a target value of the air-fuel ratio as an input value to adjust the detection value to the target value through feedback control; performing an injection valve operation process for operating the fuel injection valve based on the base injection amount corrected by the feedback process; performing a purge control process for operating the adjustment device to control the flow rate of the fluid flowing from the canister to the intake passage; and performing a correction limiting process for limiting the output value of the integral element so that a decreasing correction rate of the base injection amount has a decreasing tendency on condition that the charged air amount is decreased if the flow rate of the fluid is controlled to a value larger than zero by the purge control process.

When the amount of charged air is decreased and a purge rate is increased accordingly, the base injection amount may be excessive with respect to the injection amount required to control the detection value of the air-fuel ratio to the target value. In this case, the decreasing correction rate of the base injection amount corrected based on the output value of the integral element is increased. Consequently, in the configuration described above, the processing circuitry performs the correction limiting process on condition that the amount of charged air is decreased, thus limiting the output value of the integral element in a manner that the decreasing correction rate of the base injection amount has a decreasing tendency. The decreasing correction rate of the base injection amount can thus be smaller than that in a case where the correction limiting process is not performed. This limits excessive decreasing correction of the injection amount.

2. In the control device according to aspect 1, the purge control process may include a limitation process for operating the adjustment device to limit an increase in the flow rate of fluid flowing from the canister to the intake passage caused by a decrease in the charged air amount.

When the amount of charged air is decreased, a differential pressure obtained by subtracting the pressure in the intake passage from the pressure in the canister is increased. Consequently, if the operating state of the adjustment device is kept constant, the flow rate of the fluid flowing from the canister to the intake passage is increased. In a case where the operating state of the adjustment device is changed when the amount of charged air is decreased, it is possible to prevent the flow rate of fluid from always becoming an excessively large value. However, when the amount of charged air is decreased and then the operation of the adjustment device is changed, the ratio of fuel vapor from the canister to an air-fuel mixture, which is a combustion target in a combustion chamber, may be temporarily increased due to a temporary increase in the flow rate of fluid caused by a response delay of the adjustment device. When the ratio of the fuel vapor from the canister is temporarily increased, if the transient increase in the ratio of fuel vapor cannot be accurately reflected to setting the injection amount, the detection value of the air-fuel ratio is temporarily and excessively rich. In this case, the decreasing correction rate of the base injection amount corrected based on the output value of the integral element is increased. Then, when the change in the operating state of the adjustment device is reflected to the ratio of the fuel vapor from the canister to the air-fuel mixture in the combustion chamber, the ratio is decreased. Consequently, if the correction limiting process is not performed, the output value of the integral element becomes a value that enables excessive decreasing correction of the base injection amount. Thus, the employment of the correction limiting process is particularly advantageous.

3. In the control device according to aspect 1 or 2, the processing circuitry is configured to perform a decreasing correction process for performing a decreasing correction on the base injection amount based on a flow rate of fuel vapor flowing from the canister to the intake passage. The injection valve operation process includes operating the fuel injection valve based on the base injection amount corrected by the feedback process and the decreasing correction process. The decreasing correction process includes limiting a decreasing correction rate of the base injection amount to a predetermined rate or less.

In the configuration described above, the base injection amount is decreased and corrected by the decreasing correction process, which is feed forward control. However, the decreasing correction rate is limited to the predetermined rate or less. Thus, even if the reliability of the feed forward control is low, situations are reduced in which an error in the decreasing correction by the feed forward control become excessively large. If the processing circuitry were to perform the decreasing correction process that limits the decreasing correction rate, the air fuel mixture in the combustion chamber may temporarily become rich due to a temporary increase in the fuel vapor flowing from the canister to the intake passage as the amount of charged air decreases. Thus, the employment of the correction limiting process is particularly advantageous.

4. In the control device according to aspect 3, the correction limiting process is performed on condition that a ratio of an amount of the fuel vapor flowing into the combustion chamber to the base injection amount exceeds the predetermined rate.

In the configuration described above, on condition that the ratio of fuel vapor flowing into the combustion chamber to the base injection amount temporarily exceeds the predetermined rate, the output value of the integral element is limited in a manner that the decreasing correction rate has a decreasing tendency so that the output value of the integral element can be limited when there is a possibility of the base injection amount being excessively decreased and corrected based on the output value of the integral element. This avoids situations in which the output value of the integral element is limited in an unnecessary manner.

5. In the control device according to any one of aspects 1 to 4, a switching device is coupled to a crankshaft of the internal combustion engine to switch between a transmission state that transmits power to a drive wheel of a vehicle and a transmission-cut state that cuts the transmission of power to the drive wheel. The purge control process includes limiting a flow rate of fluid flowing from the canister to the intake passage to zero in the transmission-cut state if a reduction speed of the charged air amount is higher than or equal to a predetermined speed. The purge control process includes not limiting the flow rate to zero in the transmission state even if the reduction speed of the charged air amount is higher than or equal to the predetermined speed.

When the switching device switches the transmission-cut state to the transmission state, the load applied to the crankshaft is increased. Consequently, when an injection amount is decreased, the internal combustion engine unexpectedly stops, that is, an engine stall easily occurs. In a state which the amount of charged air is decreased, when the flow rate of fluid is zero regardless of the transmission-cut state or the transmission state, the output value of the integral element is not a value that enables excessive decreasing correction of the base injection amount due to fuel vapor from the canister. This avoids engine stalls caused by fuel vapor. In this case, however, the period in which the fuel vapor cannot be discharged from the canister is extended. In the configuration described above, only in the transmission-cut state, the flow rate of fluid is set to zero on condition that the reduction speed of the amount of charged air is higher than or equal to the predetermined speed. When the flow rate of fluid is set to zero in the transmission-cut state, the integral element is not a value that enables a decreasing correction rate of the base injection amount to be excessively increased due to fuel vapor from the canister in the transmission-cut state. In addition, it is possible to discharge the fuel vapor from the canister to the intake passage in the transmission state.

### BRIEF DESCRIPTION OF DRAWINGS

The invention, together with objects and advantages thereof, may best be understood by reference to the following description of the presently preferred embodiments together with the accompanying drawings in which:

FIG. 1 shows a control device according to one embodiment and a drive system of a vehicle;

FIG. 2 is a block diagram showing part of a process for the control device shown in FIG. 1;

FIG. 3 is a flowchart showing a procedure of a target purge rate calculation process performed by the control device shown in FIG. 1;

FIG. 4 is a flowchart showing a procedure of a feedback process performed by the control device shown in FIG. 1; and

FIG. 5 is a time chart showing the effects of the control device shown in FIG. 1.

### DETAILED DESCRIPTION OF THE EMBODIMENTS

One embodiment of a control device of an internal combustion engine will now be described with reference to the drawings.

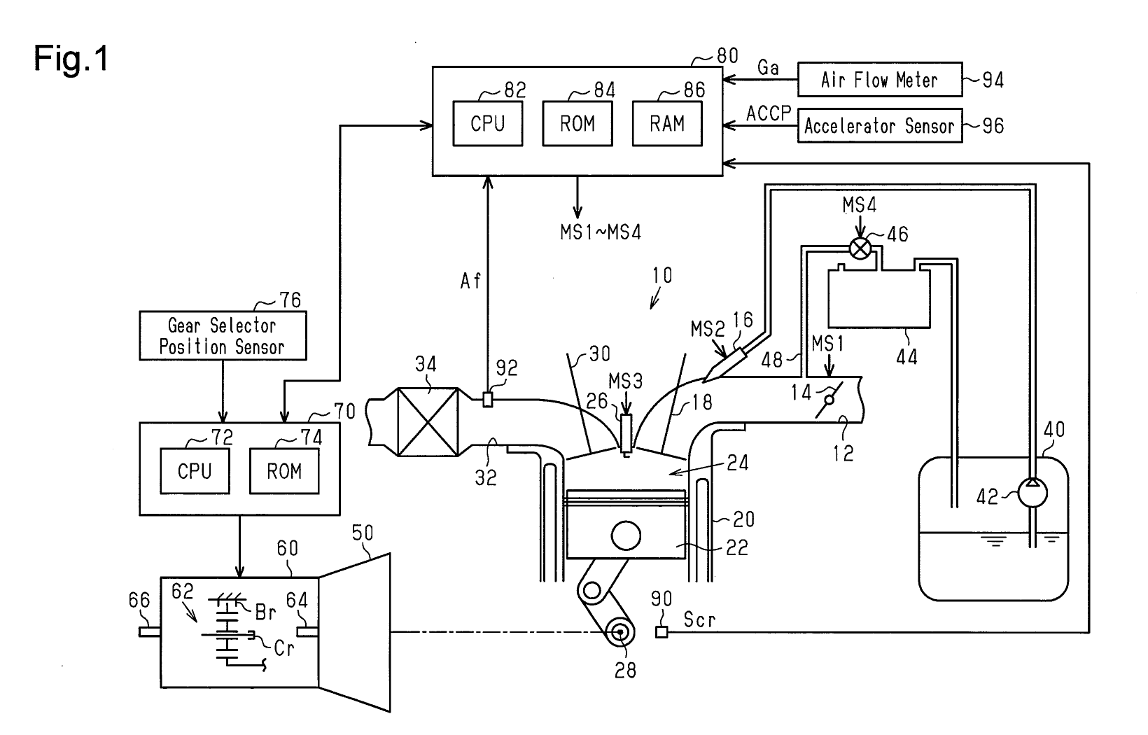

A throttle valve 14 is arranged in an intake passage 12 of an internal combustion engine 10 shown in FIG. 1, and a fuel injection valve 16 is arranged downstream of the throttle valve 14. When an intake valve 18 opens, air is suctioned into the intake passage 12, and fuel injected from the fuel injection valve 16 flows into a combustion chamber 24 that is defined by a cylinder 20 and a piston 22. The mixture of air and fuel in the combustion chamber 24 is burned by a spark discharge of an ignition device 26. This generates combustion energy that is converted by the piston 22 into rotational energy of a crankshaft 28. When an exhaust valve 30 opens, the burned air-fuel mixture is discharged as exhaust gas into an exhaust passage 32. A three-way catalyst (a catalyst 34) having an oxygen storage capability is arranged in the exhaust passage 32.

The fuel injected by the fuel injection valve 16 is stored in a fuel tank 40. The fuel stored in the fuel tank 40 is drawn into a fuel pump 42 and delivered to the fuel injection valve 16. Fuel vapor is generated in the fuel tank 40 and collected in a canister 44. The canister 44 is connected to the intake passage 12 via a purge passage 48. The purge passage 48 has a cross-sectional area for fluid flow passage that is adjustable by a purge valve 46.

A stepped transmission device 60 is connected via a torque converter 50 to the crankshaft 28. The stepped transmission device 60 includes a plurality of planetary gear mechanisms 62 and friction engagement elements. The friction engagement elements include a plurality of clutches Cr and a plurality of brakes Br. The engagement state of the friction engagement elements is switched to change the ratio of the rotation speed of an input shaft 64 to the rotation speed of an output shaft 66.

A control device 70 controls the stepped transmission device 60, that is, controls a transmission ratio, which is a control amount. The control device 70 changes the engagement state of the friction engagement elements to control the transmission ratio based on a detection value of a gear selector position sensor 76 that detects a shift position selected by a user. For example, when the gear selector position sensor 76 detects the D range, the control device 70 sets the engagement state of the friction engagement elements to obtain the appropriate transmission ratio. This allows for the transmission of power from e input shaft 64 to the output shaft 66 while maintaining a predetermined transmission ratio. Moreover, when the gear selector position sensor 76 detects, for example, the N range, the control device 70 disengages the friction engagement elements to cut the transmission of power from the input shaft 64 to the output shaft 66.

A control device 80 controls the internal combustion engine 10. That is, the control device 80 operates operation units of the internal combustion engine 10 such as the throttle valve 14, the fuel injection valve 16, the ignition device 26, and the purge valve 46 to control torque, exhaust gas components, or the like, which are control amount. When controlling a control amount, the control device 80 refers to an output signal Scr of a crank angle sensor 90 and a detection value Af of an air-fuel ratio detected by an air-fuel ratio sensor 92 arranged at the upstream side of the catalyst 34. In addition, the control device 80 also refers to an intake air amount Ga, which is detected by an air flow meter 94, and a depression amount of an accelerator pedal detected by an accelerator sensor 96 (accelerator depression amount ACCP), and the like. The control device 80 includes a CPU 82, a ROM 84, and a RAM 86. The CPU 82 executes programs stored in the ROM 84 to control a control amount.

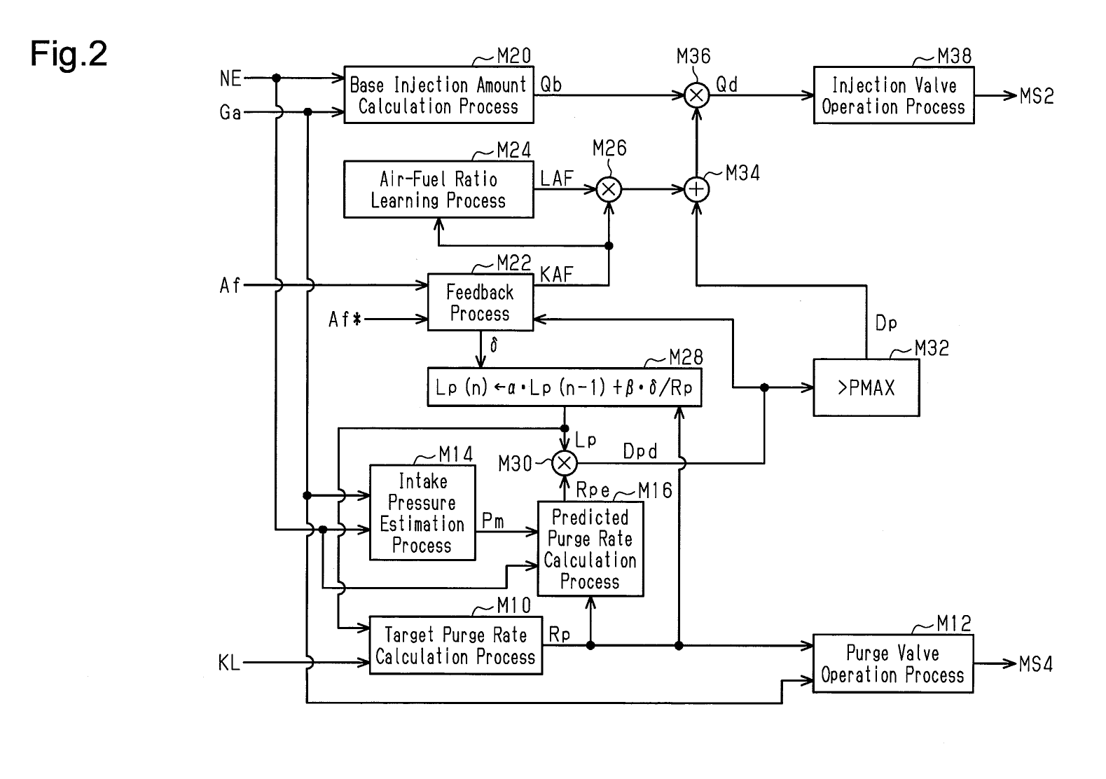

FIG. 2 shows part of a process performed by the control device 80. The process shown in FIG. 2 is implemented by the CPU 82 performing a program stored in the ROM 84.

A target purge rate calculation process M10 calculates a target purge rate Rp based on a load rate KL and a purge concentration learning value Lp, which will be described later. A purge rate is obtained by dividing the flow rate of fluid flowing from the canister 44 into the intake passage 12 by the intake air amount Ga. The target purge rate Rp is a target value for the purge rate in control. The load rate KL is a parameter indicating the charged air amount in the combustion chamber 24 and is calculated by the CPU 82 based on the intake air amount Ga. The load rate KL is the ratio of an inflow air amount in a cylinder per combustion cycle to a reference inflow air amount. The reference inflow air amount is an air inflow of a cylinder per combustion cycle when the open degree of the throttle valve 14 is the maximum. The reference inflow air amount may be variably set in accordance with a rotation speed NE. The rotation speed NE is calculated by the CPU 82 based on the output signal Scr of the crank angle sensor 90.

A purge valve operation process M12 outputs, based on the intake air amount Ga, an operation signal MS4 to the purge valve 46 to operate the purge valve 46 so that the purge rate becomes equal to the target purge rate Rp. When the target purge rate Rp is the same, the purge valve operation process M12 sets a smaller open degree for the purge valve 46 as the intake air amount Ga decreases. This is because a lower intake air amount Ga causes the pressure in the canister 44 to be higher than the pressure in the intake passage 12 so that fluid easily flows from the canister 44 to the intake passage 12.

An intake pressure estimation process M14 calculates an intake pressure Pm, which is the pressure of downstream side of the throttle valve 14 in the intake passage 12, based on the rotation speed NE and the intake air amount Ga. For example, the intake pressure estimation process M14 may be a process for calculating the intake pressure Pm using an intake manifold model and an intake valve model. In the intake manifold model, the intake pressure Pm is calculated based on a valve closing time air inflow amount and the intake air amount Ga. The valve closing time air inflow amount is obtained by subtracting the amount of air blown back to the intake passage 12 before a valve closing time of the intake valve 18 from the amount of air flowing into the combustion chamber 24 during a single combustion cycle. Specifically, in the intake manifold model, the intake pressure Pm is calculated so that the increasing rate of the intake pressure Pm is higher when a value obtained by subtracting the valve closing time air inflow amount per cylinder from the amount of intake air per cylinder, which is calculated from the intake air amount Ga, is large than when the value is small. In the intake valve model, the valve closing time air inflow amount is calculated based on the intake pressure Pm and the rotation speed NE. In the intake valve model, the valve closing time air inflow amount when the intake pressure Pm is high is calculated to be larger than that when the intake pressure Pm is low.

A predicted purge rate calculation process M16 calculates a predicted purge rate Rpe based on the target purge rate Rp, the intake pressure Pm, and the rotation speed NE. The predicted purge rate Rpe is the purge rate of the fluid in the proximity of the fuel injection valve 16. That is, even if the purge rate is controlled by the purge valve 46, the purge rate of the fluid in the proximity of the fuel injection valve 16 does not change immediately and produces a response delay. The predicted purge rate Rpe is calculated taking into account the response delay. A response delay time is set based on the intake pressure Pm and the rotation speed NE.

A base injection amount calculation process M20 calculates a base injection amount Qb based on the rotation speed NE and the intake air amount Ga. The base injection amount Qb is an operation variable in open loop control for controlling the air-fuel ratio of an air-fuel mixture to be combusted in the combustion chamber 24 to a target air-fuel ratio. In practice, the base injection amount calculation process M20 may calculate and estimate a valve closing time air inflow amount and calculate the base injection amount Qb based on the valve closing time air inflow amount, as in the intake pressure estimation process M14. A stoichiometric air-fuel ratio is exemplified as the target air-fuel ratio in the present embodiment.

A feedback process M22 calculates a feedback operation amount KAF that is an operation variable for adjusting the detection value Af of the air-fuel ratio sensor 92 to a target value Af* through feedback control. The feedback operation amount KAF is a correction coefficient of the base injection amount Qb and is expressed as “1+δ.” When a correction rate δ is “0,” the correction rate of the base injection amount Qb is zero. When the correction rate δ is larger than “0,” the base injection amount Qb is corrected and increased. When the correction rate δ is smaller than “0,” the base injection amount Qb is corrected and decreased. The target value Af* may be the detection value Af of the target air-fuel ratio but instead may be a value obtained by correcting the detection value Af of the target air-fuel ratio to adjust the amount of oxygen storage of the catalyst 34.

An air-fuel ratio learning process M24 sequentially updates an air-fuel ratio learning value LAF during an air-fuel ratio learning period to decrease the deviation of a feedback operation amount KAF from “1.” In particular, the air-fuel ratio learning period is a period during which the target purge rate Rp is “0” in the present embodiment. When the absolute value of the difference between the feedback operation amount KAF and “1” is less than or equal to a predetermined value, it is determined that the air-fuel ratio learning value LAF has converged, on condition that it is determined that the air-fuel ratio learning value LAP has converged, the target purge rate calculation process M10 sets the target purge rate Rp to a value larger than “0.”

A coefficient combining process M26 integrates the feedback operation amount KAF and the air-fuel ratio learning value LAF.

A purge concentration learning process M28 calculates a purge concentration learning value Lp based on the correction rate δ. Fuel vapor flows from the canister 44 into the intake passage 12. Thus, it is necessary to correct the base injection amount Qb to control the air-fuel ratio at the target air-fuel ratio. The purge concentration learning value Lp is a value obtained by converting a correction rate for correcting the base injection amount Qb into a rate for one percent of the purge rate. It is assumed in the present embodiment that deviation of the feedback operation amount KAF from “1” when the target purge rate Rp is controlled to be larger than “0” is caused by only the fuel vapor flowing from the canister 44 into the intake passage 12. That is, the correction rate δ is handled as correction rate for correcting deviation of the base injection amount Qb from an injection amount required to control the air-fuel ratio at the target air-fuel ratio, in which the deviation is caused by the fuel vapor flowing from the canister 44 into the intake passage 12. However, the correction rate δ is in accordance with the purge rate. Thus, the purge concentration learning value Lp is calculated as a value for one percent of the purge rate “δ/Rp.”

Specifically, the current purge concentration learning value Lp(n) is an exponential moving average processing value of the previous purge concentration learning value Lp(n−1) and the correction rate for one percent of the purge rate “δ/Rp.” FIG. 2 shows weight coefficients α and β for the preceding purge concentration learning value Lp(n−1) and the value for one percent of the purge rate “δ/Rp,” respectively. In this case, α+β=1 is satisfied. The target purge rate Fop is controlled to be a value larger than “0” when the air-fuel ratio learning value LA F is converged. The correction rate δ is thus normally a correction rate for reducing the base injection amount Qb by the amount of fuel vapor, which is a value less than or equal to zero. Consequently, the purge concentration learning value Lp is also a value less than or equal to zero.

A requested correction rate calculation process M30 multiplies the purge concentration learning value Lp by the predicted purge rage Rpe to calculate a requested purge correction rate Dpd. The requested purge correction rate Dpd is a correction variable required for decreasing correction of the base injection amount Qb by the amount of fuel vapor. Further, the requested purge correction rate Dpd is a negative value.

A guard process M32 outputs a purge correction rate Dp that is obtained by limiting the requested purge correction rate Dpd to a value having an absolute value that is smaller than the absolute value of a specified rate PMAX (<0). The guard process M32 limits the decreasing correction rate of the base injection amount Qb achieved by the purge correction rate Dp to the absolute value of the specified rate PMAX or less. Particularly, when the decreasing correction rate of the base injection amount Qb is a positive value, the base injection amount Qb is decreased. The guard process M32 is achieved by selecting the maximum value of the requested purge correction rate Dpd and the specified rate PMAX. The absolute value of the specified rate PMAX is smaller than “1,” for example, “0.3 to 0.5.” The setting of the specified rate PMAX corresponds to the setting of an upper limit guard value of the target purge rate Rp, as will be described later.

A correction coefficient calculation process M34 outputs the sum of an output value of the coefficient combining process M26 and the purge correction rate Dp as a correction coefficient.

The correction process M36 multiplies the base injection amount Qb by an output value of the correction coefficient calculation process M34 to calculate a requested injection amount Qd. An injection valve operation process M38 outputs an operation signal MS2 to the fuel injection valve 16 to operate the fuel injection valve 16 so that the amount of fuel injected from the fuel injection valve 16 is in accordance with the requested injection amount Qd.

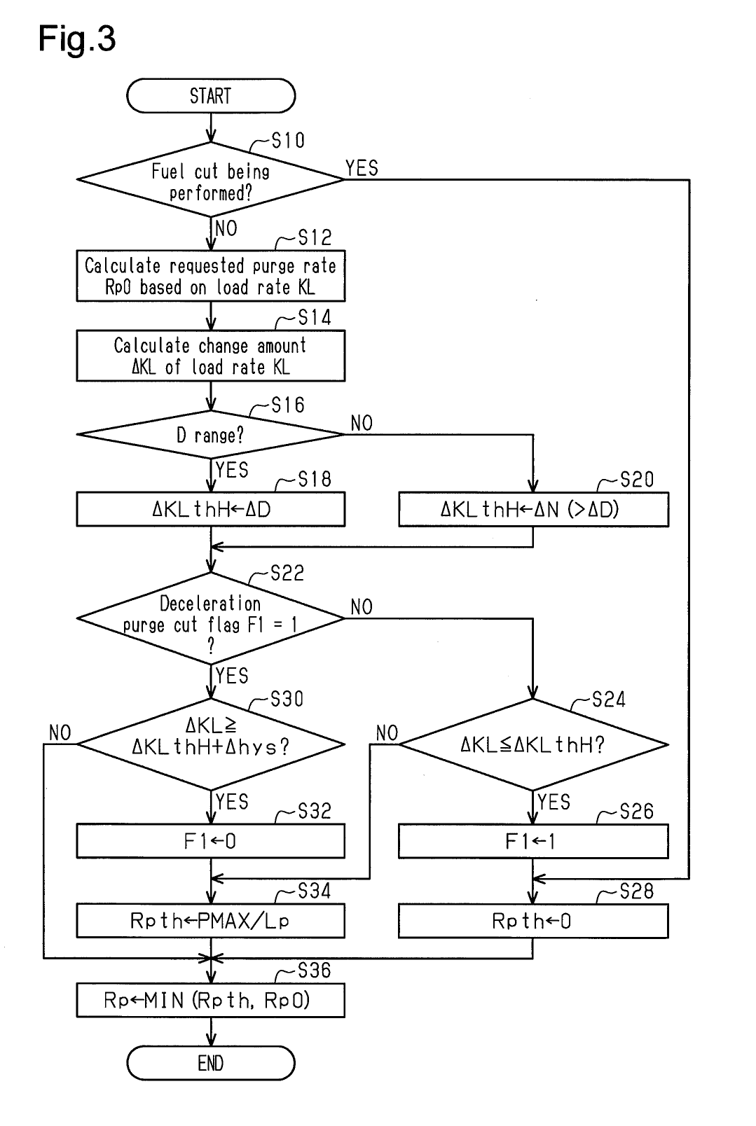

FIG. 3 shows the procedure of the target purge rate calculation process M10. The process shown in FIG. 3 is implemented by the CPU 82 that repeatedly executes programs stored in the ROM 84, for example, in a predetermined period on condition that the period is not an air-fuel ratio learning period. Hereinafter, the combination of S and a number, with S added in front of the number, represents a step number.

In the series of processes shown in FIG. 3, the CPU 82 first determines whether or not fuel cut is being performed (S10). The fuel cut process is performed by the CPU 82 on condition that a predetermined time has elapsed from when the accelerator depression amount ACCP became zero (for example, 500 ms to 1500 ms) with the rotation speed NE in a predetermined speed area. During the fuel cut process, the feedback operation amount KAF is fixed to “1” by the CPU 82.

When the CPU 82 determines that the fuel cut is not being performed (NO in S10), the CPU 82 calculates a requested purge rate Rp0 based on the load rate KL (S12). For example, the CPU 82 sets the requested purge rate Rp0 when the load rate KL is small to a smaller value than that when the load rate KL is large. This avoids a situation in which the requested injection amount Qd is less than a minimum injection amount of the fuel injection valve 16. This process is implemented by, for example, storing map data in which the load rate KL is an input variable and the requested purge rate Rp0 is an output variable in the ROM 84 and by using the map to obtain the requested purge rate Rp0 with the CPU 82. The map data is a data set of discrete values of input variables and a value of an output variable corresponding to each of the values of the input variables. In the map calculation, when an input variable matches any of the input variables in the map data, the corresponding output variable in the map data may be output as a calculation result. When an input variable does not match any of the input variables in the map data, a value obtained by interpolation of a plurality of output variables included in the map data may be output as a calculation result.

Next, the CPU 82 calculates a change amount ΔKL (a change speed) of the load rate KL for a predetermined period (S14). The CPU 82 then communicates with the control device 70 to determine whether or not the current shift range is the D range (S16). When the CPU 82 determines that the current shift range is the D range (YES in S16), a specified amount ΔD of the D range is substituted for a threshold ΔKLthH of the change amount ΔKL (S18). The specified amount ΔD is a negative value and, in particular, the absolute value of the specified amount ΔD is set to a value that is too large to be the decreasing rate of the load rate KL. When the CPU 82 determines that the current shift range is not the D range (NO in S16), a predetermined variable ΔN of an N range is substituted for the threshold ΔKLthH of the change amount ΔKL (S20). The predetermined variable ΔN is a negative value and, in particular, the absolute value of the predetermined variable ΔN is set to a value that would be normal as the reduction speed of the load rate KL.

Next, the CPU 82 determines whether or not a deceleration purge cut flag F1 is “1” (S22). The deceleration purge cut flag F1 is “1” when the change amount ΔKL is less than or equal to the threshold ΔKLthH and the target purge rate Rp is thus limited to “0.” Further, the deceleration purge cut flag F1 is “0” when the target purge rate Rp is not limited. When the CPU 82 determines that the deceleration purge cut flag F1 is “0” (NO in S22), the CPU 82 determines whether or not the change amount ΔKL is less than or equal to the threshold ΔKLthH (S24). When the CPU 82 determines that the change amount ΔKL is less than or equal to the threshold ΔKLthH (YES in S24), the deceleration purge cut flag F1 is set to “1” (S26), and “0” is substituted for a guard value Rpth of the target purge rate Rp (S28).

When the CPU 82 determines that the deceleration purge cut flag F1 is “1” (YES in S22), the CPU 82 determines whether or not the change amount ΔKL is larger than or equal to a value obtained by adding a hysteresis width Δhys to the threshold ΔKLthH (S30). The process of S30 determines whether or not the reduction speed of the load rate KL has decreased and determines whether a process for setting the guard value Rpth to “0” has ended. The hysteresis width Δhys is a positive value and is set for reducing hunting in which the deceleration purge cut flag F1 repeatedly changes between “1” and “0” within a short period.

When the CPU 82 determines that the change amount ΔKL is larger than or equal to a value obtained by adding the hysteresis width Δhys to the threshold ΔKLthH (YES in S30), “0” is substituted for the deceleration purge cut flag F1 (S22). When the process of S32 is completed or when a negative determination is made in S24, the CPU 82 substitutes a value obtained by dividing the specified rate PMAX by the purge concentration learning value Lp for the guard value Rpth (S34). This process is set for the purpose of limiting the decreasing correction rate of the base injection amount Qb obtained from the amount of fuel vapor flowing from the canister 44 into the intake passage 12 to a specified rate |PMAX| that is the absolute value of the specified rate PMAX. As described above, the specified rate |PMAX| is smaller than “1.” This is because even if a converged air-fuel ratio learning value LAF is used, the deviation of the feedback operation amount KAF from “1” is not necessarily caused by the fuel vapor flowing from the canister 44 into the intake passage 12. In the present embodiment, when the rate of fuel vapor relative to the charged air amount in the combustion chamber 24 is excessively large, the decreasing correction rate obtained by the purge correction rate Dp is limited to the absolute value of the specified rate PMAX or less taking into account that controllability of the air-fuel ratio may deteriorate.

When the processes of S34 and S28 are completed or when a negative determination is made at S30, the CPU 82 substitutes a smaller one of the requested purge rate Rp0 and the guard value Rpth for the target purge rate Rp (S36).

When the CPU 82 determines that the fuel-cut is being performed (YES in S10), the CPU 82 proceeds S28.

When the process of S36 is completed, the CPU 82 temporarily ends the series of processes shown in FIG. 3.

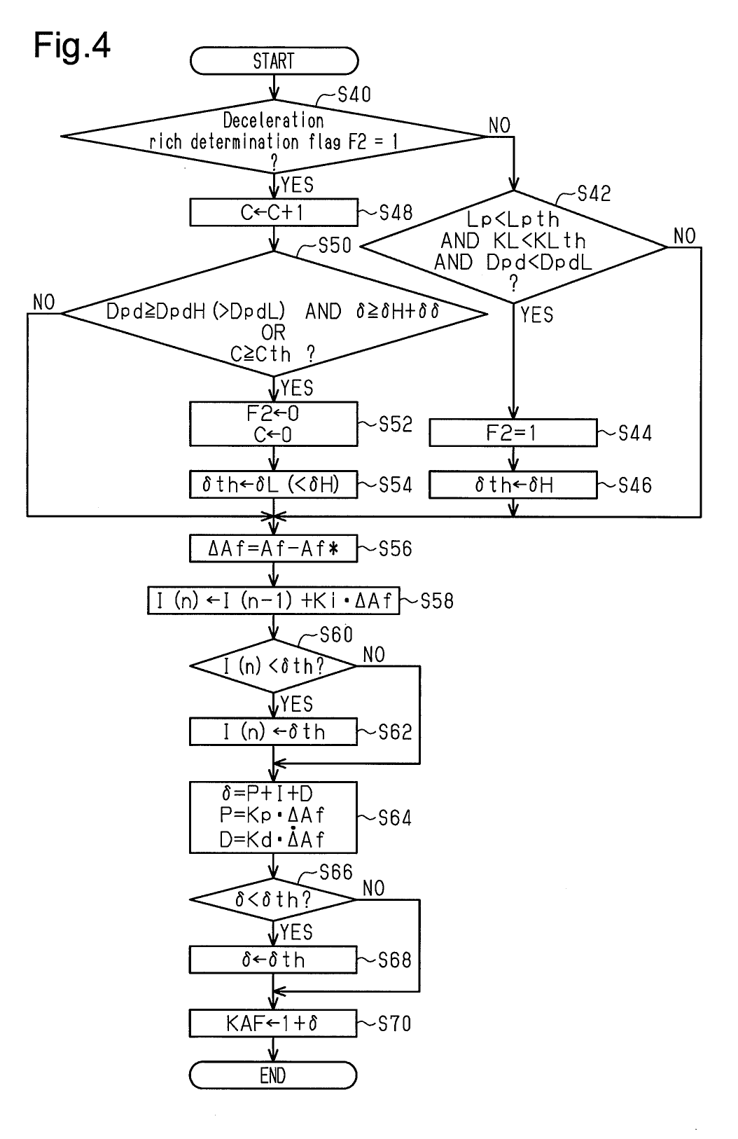

FIG. 4 shows the procedure of the feedback process M22. The process shown in FIG. 4 is implemented by the CPU 82 that repeatedly executes programs stored in the ROM 84, for example, during a predetermined period on condition that fuel cut process is not performed.

In the series of processes shown in FIG. 4, the CPU 82 first determines whether or not a deceleration rich determination flag F2 is “1” (S40). The deceleration rich determination flag F2 is “1” is determined when in a period in which an air-fuel ratio is rich because of the decrease in the load rate KL. When not in such a period, the deceleration rich determination flag F2 is “0.” When the CPU 82 determines that the deceleration rich determination flag F2 is “0” (NO in S40), the CPU 82 determines whether or not conditions (A) to (C) described below are all satisfied (S42).

Condition (A): The purge concentration learning value Lp is smaller than a specified concentration Lpth. The specified concentration Lpth is a negative value. This condition is used for determining that the ratio of fuel vapor obtained by dividing a fuel vapor flow rate by the flow rate of air flowing in the intake passage 12 is excessively large because the ratio of fuel vapor in fluid flowing from the canister 44 into the intake passage 12 is large and the load rate KL has been decreased accordingly.

Condition (B): the load rate KL is smaller than a specified value KLth.

Condition (C): The requested purge correction rate Dpd is smaller than a first threshold DpdL. The first threshold DpdL is a negative value. In the present embodiment, the first threshold DpdL is set to be smaller than the specified rate PMAX. When this condition is satisfied, it is impossible to sufficiently limit situations in which a base injection amount becomes excessive relative to an injection amount required to achieve a target air-fuel ratio due to fuel vapor from the canister 44 under feed forward control using the purge correction rate Dp. If feedback control is not executed, the requested injection amount Qd may be excessive for achieving the target air-fuel ratio.

When the CPU 82 determines that conditions (A) to (C) are all satisfied (YES in S42), the deceleration rich determination flag F2 is set to “1” (S44) and a value SR that is negative and larger than a normal value is substituted for a guard value δth of a correction rate δ (S46). This process is performed to limit the correction rate δ so as not to be a value that enables excessive and large decreasing correction of the base injection amount Qb.

When the CPU 82 determines that the deceleration rich determination flag F2 is “1” (YES in S40), a counter C for measuring a duration in which the deceleration rich determination flag F2 is “1” is incremented (S48). Next, the CPU 82 determines whether or not conditions (D) and (E) described below are satisfied and/or whether or not condition (F) is satisfied (S50).

Condition (D): The requested purge correction rate Dpd is larger than or equal to a second threshold DpdH. The second threshold DpdH is a negative value and larger than the first threshold DpdL. In particular, the second threshold DpdH is set to a value greater than or equal to the specified rate PMAX. When condition (D) is satisfied, the purge correction rate Dp is the requested purge correction rate Dpd. Thus, the base injection amount Qb can be decreased by the amount of fuel vapor through the feed forward control using the purge correction rate Dp.

Condition (E): The correction rate δ is larger than or equal to a value obtained by adding a hysteresis variable δδ to a value δH. The hysteresis variable δδ is a positive value and smaller than the absolute value of the value δH. When condition (E) is satisfied, it is determined that the correction rate δ based on the difference between the detection value Af and the target value Af* is not limited by the guard value δth and that the decreasing correction rate of the base injection amount Qb corrected based on the feedback operation amount KAF has been decreased to a certain extent.

Condition (F): The value of counter C is larger than or equal to the threshold Cth. Condition (F) is set to prevent the period in which the feedback operation amount KAF is limited based on the process of S46 from becoming excessively long.

When the CPU 82 determines that conditions (D) and (E) are satisfied and/or condition (F) is satisfied (YES in S50), the deceleration rich determination flag F2 is set to “0” and the counter C is initialized (S52). The CPU 82 then substitutes the value δL smaller than the value δH for the guard value δth of the correction rate δ (S54).

When the processes of S46 and S54 are completed or when a negative determination is made in S42 of S50, the CPU 82 calculates the deviation ΔAf of the detection value Af from the target value Af* (S56). Next, the CPU 82 adds a value obtained by multiplying the deviation ΔAf by an integral gain Ki to the previous integral element I(n−1) to calculate the current integral element I(n) (S58). Next, the CPU 82 determines whether the current integral element I(n) is less than the guard value δth (S60). The process in S60 determines whether or not the integral element I(n) is a value that enables excessive decreasing correction of the base injection amount Qb. When the CPU 82 determines that the integral element I(n) is less than the guard value δth (YES in S60), the guard value δth is substituted for the integral element I(n) (S62).

When the process of S62 is completed or when a negative determination is made in the process of S60, the CPU 82 adds a proportional element P and a differential element D to the integral element I to calculate the correction rate δ (S64). Next, the CPU 82 determines whether the correction rate δ is less than the guard value δth (S66). When the CPU 82 determines that the correction rate δ is less than the guard value δth (YES in S66), the guard value δth is substituted for the correction rate δ (S68). When the process of S68 is completed or when a negative determination is made in the process of S66, the CPU 82 substitutes “1+δ” for the feedback operation amount KAF (S70).

When the process of S70 is completed, the CPU 82 temporarily ends the series of processes shown in FIG. 4.

The operation of the present embodiment will now be described.

If the load rate KL is decreased, when the open degree of the purge valve 46 remains fixed, a purge rate is increased. Consequently, the CPU 82 changes the open degree of the purge valve 46 to a smaller value to control the purge rate at the target purge rate Rp. However, the load rate KL (the intake air amount Ga) is actually decreased and the open degree of the purge valve 46 is then changed to a smaller value. Thus, a response delay occurs before the open degree of the purge valve 46 is decreased to an appropriate value for the decreased load rate KL. Thus, the purge rate in the proximity of the fuel injection valve 16 in the intake passage 12 is temporarily increased. This temporarily increases the ratio of fuel vapor from the canister 44 to fluid flowing in the proximity of the fuel injection valve 16. In particular, when the concentration of the fuel vapor in the fluid flowing from the canister 44 into the intake passage 12 is high, the ratio of the fuel vapor from the canister 44 to the fluid flowing in the proximity of the fuel injection valve 16 temporarily becomes excessively large.

If the requested purge correction rate Dpd is used, the base injection amount Qb may be corrected and decreased by the amount of the fuel vapor from the canister 44, which temporarily becomes excessively large, through feed forward control. However, when taking into account the reliability of the requested purge correction rate Dpd, an excessively large decreasing correction rate of the base injection amount Qb is not desirable. Consequently, a correction rate based on the feed forward control is limited by the specified rate PMAX through the guard process M32 in the present embodiment. In this case, however, when the load rate KL starts to decrease, the requested injection amount Qd is larger than an appropriate value for achieving a target air-fuel ratio, and the detection value Af is richer than the target value Af*. The feedback operation amount KAF is thus less than “1” to correct and decrease the base injection amount Qb. When the guard value δth of the integral element is fixed to the value δL, the integral element I is negative and the absolute value thereof is excessively large. For this reason, even if the ratio of the fuel vapor from the canister 44 to the fluid in the proximity of the fuel injection valve 16 in the intake passage 12 is decreased as the open degree of the purge valve 46 decreases, the integral element I is still excessively large and the requested injection amount Qd may be excessively decreased. In the present embodiment, by changing the absolute value of the guard value δth to a smaller value, it is possible to prevent the integral element I from becoming excessively large. As a result, it is possible to prevent the decreasing correction rate achieved by the feedback operation amount KAF of the base injection amount Qb from becoming excessively large when the ratio of the fuel vapor from the canister 44 to the fluid in the proximity of the fuel injection valve 16 in the intake passage 12 is decreased as the open degree of the purge valve 46 decreases.

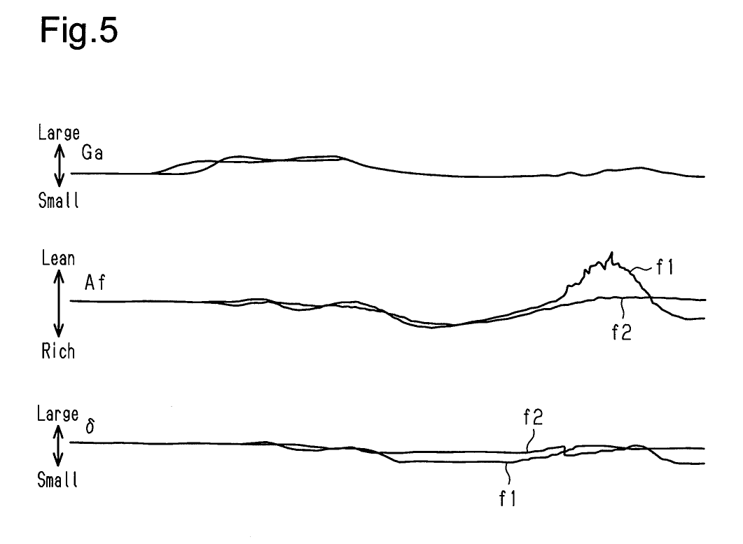

FIG. 5 shows the transition of the intake air amount Ca, the detection value Af, and the correction rate δ in a comparative example in which the guard value δth is fixed to the value δL and in the present embodiment in which the guard value δth is changed to the value δH. FIG. 5 shows the detection value Af and the correction rate δ of the comparative example with a curve f1 and the detection value Af and the correction rate δ of the present embodiment with a curve f2. As shown in FIG. 5, in the present embodiment, the detection value Af is prevented from becoming excessively lean, after it is temporarily richened as the intake air amount Ga decreases.

The correction rate δ is limited when the load rate KL is decreased in the present embodiment. Thus, the degree to which the detection value Af is rich as the load rate KL decreases may be higher than that in a case where the correction rate δ is not limited. It is possible to sufficiently reduce unburned fuel in exhaust gas discharged to the exhaust passage 32 during the period in which the detection value Af is rich using the oxygen stored in the catalyst 34.

The present embodiment has the advantages described below.

(1) When the change amount ΔKL of the load rate KL is less than or equal to the predetermined variable ΔN in the N range, the target purge rate Rp is limited to zero. Further, even when the change amount ΔKL of the load rate KL is less than or equal to the predetermined variable ΔN in a D range, the target purge rate Rp is not limited to zero. When the N range is changed to the D range, the load applied to the crankshaft 28 is increased. Consequently, when an injection amount is decreased, the internal combustion engine 10 unexpectedly stops, that is, an engine stall easily occurs. If the load rate KL is decreased, when the target purge rate Rp is zero regardless of the D range or the N range, the integral element I is not a value that enables excessive decreasing correction of the base injection amount Qb due to fuel vapor from the canister 44. Thus, fuel vapor from the canister 44 will not cause an engine stall. In this case, however, the period in which fuel vapor cannot be discharged from the canister 44 is extended. In the present embodiment, only in the N range, the target purge rate Rp is set to zero on condition that the chance amount ΔKL of the load rate KL is less than or equal to the predetermined variable N. When the target purge rate Rp is set to zero in the N range, the integral element I is not a value that excessively increases the decreasing correction rate of the base injection amount because of the fuel vapor from the canister 44 in the N range. In addition, it is possible to discharge the fuel vapor from the canister 44 to the intake passage 12 in the D range.

Corresponding Relationship

The corresponding relationship between the items in the above embodiments and the items described in the “Summary” column will now be described. Hereinafter, the corresponding relationship is described for each number in the “Summary.”

[1] The adjustment device corresponds to the purge valve 46. The purge control process corresponds to the target purge rate calculation process M10 and the purge valve operation process M12. The correction limiting process corresponds to the processes of S46, S60, and S62. Taking into account the process of S34 and the like, condition (C) is not satisfied in a stable state. Condition (C) is satisfied when the charged air amount in the combustion chamber 24 is decreased. That is, when condition (C) is satisfied, or, “on condition that the charged air amount is decreased,” the process of S46 is performed.

[2] The limitation process corresponds to a process in which the purge valve operation process M12 outputs the operation signal MS4 to the purge valve 46 based on the intake air amount Ga and the target purge rate Rp.

[3] The decreasing correction process corresponds to the requested correction rate calculation process M30, the guard process M32, the correction coefficient calculation process M34, and the correction process M36. The predetermined rate compared with a decreasing correction rate corresponds to the absolute value of the specified rate PMAX.

[4] The condition for performing the correction limiting process corresponds to the process of S42 (particularly, condition (C) (Dpd<DpdL)).

[5] The switching device corresponds to the stepped transmission device 60, the transmission state corresponds to the D range, the transmission-cut state corresponds to the N range, and the purge control process corresponds to the processes of S16 to S20, S24 to S28, and S36. The reduction speed corresponds to the change amount ΔKL, and the predetermined speed compared with the reduction speed corresponds to the absolute value of the predetermined variable ΔN.

### Other Embodiments

At least one of the items in the above embodiment may be changed as described below.

“Feedback Process”

The sum of an output value of a proportional element, an output value of an integral element, and an output value of a differential element is the correction rate δ in the above embodiment. Instead, for example, the sum of the output value of the proportional element and the output value of the integral element may be the correction rate δ. Alternatively, for example, the output value of the integral element may be the correction rate δ.

“Correction Limiting Process”

In addition to the absolute value of the integral element I, the absolute value of the correction rate δ is limited to the guard value δth or greater in the above embodiment. However, this is not a limitation.

Instead of the process of S42, the CPU 82 may omit condition (A) and determine whether conditions (B) and (C) are both satisfied. Further, for example, instead of the process of S42, the CPU 82 may omit condition (B) and determine whether or not conditions (A) and (C) are both satisfied. Instead of the process of S42, the CPU 82 may omit conditions (A) and (B), and determine whether or not condition (C) is satisfied. Instead of the process of S42, the CPU 82 may omit condition (C) and determine whether or not conditions (A) and (B) are both satisfied. In this case, when conditions (A) and (B) are both satisfied, depending on the setting of the specified concentration Lpth and the specified value KLth, it can be assumed that the ratio of the amount of fuel vapor flowing into the combustion chamber 24 to the base injection, amount Qb exceeds the specified rate |PMAX| when the intake air amount is decreased.

Instead of the process of S50, for example, the CPU 82 may determine whether or not conditions (D) and (F) are both satisfied or whether conditions (B) and (F) are both satisfied. Alternatively, for example, the CPU 82 may only determine whether or not conditions (D) and (B) are both satisfied or only whether condition (F) is satisfied.

“Requested Injection Amount Qd”

The requested injection amount Qd is a value obtained by correcting the base injection amount Qb using the feedback operation amount KAF, the air-fuel ratio learning value LAF, and the purge correction rate Dp in the above embodiment. Instead, for example, as will be described below in “Decreasing Correction Process,” the requested injection amount Qd may be a value obtained by correcting the base injection amount Qb using the feedback operation amount KAF and the air-fuel ratio learning value LAF and not using the purge correction rate Dp. Moreover, the requested injection amount Qd may be a value obtained by correcting the base injection amount Qb using the feedback operation amount KAF.

“Limitation Process”

In the above embodiment, the input parameter of the limitation process for operating the purge valve 46 to limit increases in the flow rate of fluid flowing from the canister 44 into the intake passage 12 due to a decrease in the charged air amount is not limited to the intake air amount Ga. For example, the input parameter may be the load rate KL or an intake pressure.

As will be described below in “Adjustment Device,” when a pump serves as the adjustment device, an operation signal may be changed so as to reduce power consumption of the pump when the intake air amount Ga is decreased. The intake air amount is decreased and thus the degree to which the pressure in the canister 44 exceeds the pressure in the intake passage 12 is increased. Fluid can thus easily flow from the canister 44 into the intake passage 12. The fluid flowing from the canister 44 into the intake passage 12 can also be limited by changing the operation signal to reduce the consumption power of the pump.

“Decreasing Correction Process”

The process for limiting the absolute value of the purge correction rate Dp to the absolute value of the specified rate PMAX or less does not necessarily have to be performed. If this process is not performed, for example, when the requested purge correction rate Dpd is the product of the target purge rate Rp and the purge concentration learning value Lp, it is impossible to reflect the fact that the actual ratio of fuel vapor in the proximity of the fuel injection valve 16 is temporarily increased and then decreased to the requested purge correction rate Dpd. Consequently, the decreasing correction rate of the base injection amount Qb obtained by the integral element I may be excessively increased. Thus, the limiting of the integral element I so that the decreasing correction rate has a tendency to decrease is thus effective.

The decreasing correction process, which is feed forward correction control based on the flow rate of fuel vapor from the canister 44, does not necessarily have to be executed.

“Purge Control Process”

The requested purge rate Rp0 is variably set based on the load rate KL in the above embodiment. However, the parameter for variably setting the requested purge rate Rp0 is not limited to the load rate KL. Alternatively, the requested purge rate Rp0 may be a fixed value. The requested purge rate Rp0 may control the open degree of the purge valve 46 in a binary manner so that the purge valve 46 is in a fully closed state or in a predetermined open degree state. In this case, as the load rate KL decreases, the purge rate stably increases. Consequently, the decreasing correction rate obtained by the integral element I may be increased and the requested injection amount Qd may be excessively decreased by an overshoot. Thus, the limiting of the decreasing correction rate is effective.

In the above embodiment, the target purge rate Rp is zero in the N range on condition that the load rate KL is decreased, and the target purge rate Rp is not zero in the D range even when the load rate KL is decreased. Instead, for example, the threshold ΔKLthH of the change amount ΔKL in the D range may be less than that in the N range and be set to a value that can actually be the change amount ΔKL. The threshold ΔKLthH in the D range does not have to be different from that in the N range. The target purge rate Rp may be set so as not to be zero in both of the ranges.

“Adjustment Device”

The adjustment device that adjusts the flow rate of fluid flowing from a canister into an intake passage is not limited to the purge valve 46. For example, the adjustment device may be configured to include a pump that suctions fluid in the canister 44 and discharges the fluid to the intake passage 12. The configuration in which the adjustment device includes the pump is particularly effective when the internal combustion engine 10 includes a supercharger.

“Switching Device”

The switching device is not limited to the stepped transmission device 60. For example, the switching device may include a planetary gear mechanism mechanically coupled to a crankshaft of the internal combustion engine 10, a rotating shaft and a drive wheel of a rotating electric machine, and the rotating electric machine. In this case, when the torque of the rotating electric machine is zero, it is possible to cut transmission of power from the crankshaft to the drive wheel.

“Control Device”

The control device is not limited to devices that include the CPU 82 and the ROM 84 and perform a software process. For example, a dedicated hardware circuit (e.g., ASIC) that processes at least part of the software process performed in the above embodiment may be included. That is, it is only required that the control device is circuitry including any of the following (a) to (c). (a) Circuitry including a processor that processes all the processes described above with a program and a program storage device such as a ROM that stores the program. (b) Circuitry including a processor that performs some of the processes described above with a program, a program storage device, and a dedicated hardware circuit that performs the remaining processes. (c) Circuitry including a dedicated hardware circuit that performs all of the processes described above. A plurality of software processing circuits including the processor and the program storage device or a plurality of dedicated hardware circuits may be used. That is, it is only required that the processes described above be performed by processing circuitry including at least either one or more software processing circuits and one or more dedicated hardware circuits. That is, the computer readable medium any usable medium that is accessible through versatile or dedicated computers.

“Others”

The fuel injection valve does not have to inject fuel into the intake passage 12 and may, for example, inject fuel into the combustion chamber 24.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

1. A control device for an internal combustion engine, wherein the internal combustion engine includes a fuel injection valve, a canister configured to collect fuel vapor generated in a fuel tank storing fuel supplied to the fuel injection valve, and an adjustment device configured to adjust a flow rate of fluid flowing from the canister to an intake passage, the control device comprising processing circuitry configured to perform:
a base injection amount calculation process for calculating a base injection amount based on a charged air amount in a combustion chamber of the internal combustion engine;
a feedback process for correcting the base injection amount based on an output value of an integral element obtained by using a difference between a detection value of an air-fuel ratio and a target value of the air-fuel ratio as an input value to adjust the detection value to the target value through feedback control;
an injection valve operation process for operating the fuel injection valve based on the base injection amount corrected by the feedback process;
a purge control process for operating the adjustment device to control the flow rate of the fluid flowing from the canister to the intake passage; and
a correction limiting process for limiting the output value of the integral element so that a decreasing correction rate of the base injection amount has a decreasing tendency on condition that the charged air amount is decreased if the flow rate of the fluid is controlled to a value larger than zero by the purge control process.

2. The control device according to claim 1, wherein the purge control process includes a limitation process for operating the adjustment device to limit an increase in the flow rate of fluid flowing from the canister to the intake passage caused by a decrease in the charged air amount.

3. The control device according to claim 1, wherein
the processing circuitry is configured to perform a decreasing correction process for performing a decreasing correction on the base injection amount based on a flow rate of fuel vapor flowing from the canister to the intake passage,
the injection valve operation process includes operating the fuel injection valve based on the base injection amount corrected by the feedback process and the decreasing correction process, and
the decreasing correction process includes limiting a decreasing correction rate of the base injection amount to a predetermined rate or less.

4. The control device according to claim 3, wherein the correction limiting process is performed on condition that a ratio of an amount of the fuel vapor flowing into the combustion chamber to the base injection amount exceeds the predetermined rate.

5. The control device according to claim 1, wherein
a switching device is coupled to a crankshaft of the internal combustion engine to switch between a transmission state that transmits power to a drive wheel of a vehicle and a transmission-cut state that cuts the transmission of power to the drive wheel;
the purge control process includes limiting a flow rate of fluid flowing from the canister to the intake passage to zero in the transmission-cut state if a reduction speed of the charged air amount is higher than or equal to a predetermined speed; and
the purge control process includes not limiting the flow rate to zero in the transmission state even if the reduction speed of the charged air amount is higher than or equal to the predetermined speed.

6. A method for controlling an internal combustion engine, wherein the internal combustion engine includes a fuel injection valve, a canister configured to collect fuel vapor generated in a fuel tank storing fuel supplied to the fuel injection valve, and an adjustment device configured to adjust a flow rate of fluid flowing from the canister to an intake passage, the method comprising:
performing a base injection amount calculation process for calculating a base injection amount based on a charged air amount in a combustion chamber of the internal combustion engine;
performing a feedback process for correcting the base injection amount based on an output value of an integral element obtained by using a difference between a detection value of an air-fuel ratio and a target value of the air-fuel ratio as an input value to adjust the detection value to the target value through feedback control;
performing an injection valve operation process for operating the fuel injection valve based on the base injection amount corrected by the feedback process;
performing a purge control process for operating the adjustment device to control the flow rate of the fluid flowing from the canister to the intake passage; and
performing a correction limiting process for limiting the output value of the integral element so that a decreasing correction rate of the base injection amount has a decreasing tendency on condition that the charged air amount is decreased if the flow rate of the fluid is controlled to a value larger than zero by the purge control process.
